(19) United States
(12) Patent Application Publication
(10) Pub. No.: US 2016/0205390 A1
(43) Pub. Date: Jul. 14, 2016

(54) METHOD FOR DISPLAYING ON A SCREEN AN OBJECT SHOWN IN A 3D DATA SET

(71) Applicant: SIEMENS AKTIENGESELLCHAFT, Muenchen (DE)

(72) Inventor: KARL BARTH, HOECHSTADT (DE)

(21) Appl. No.: 14/913,392

(22) PCT Filed: Jun. 16, 2014
(86) PCT No.: PCT/EP2014/062544

§ 371 Date: Feb. 22, 2016

(30) Foreign Application Priority Data
Aug. 23, 2013 (DE) 10 2013 216 858.6

(51) Int. Cl. H04N 13/04; G06T 7/00

(52) U.S. Cl. CPC H04N 13/0493; G06T 7/0012; H04N 13/0497

(57) ABSTRACT

In order to display on a screen, in a way suitable for surgical applications, an object shown in a 3D data set, there is provided a display with various views in combination with a 3D operating element on a common screen. Turning the 3D operating element about an axis of rotation in one window results in a corresponding change of views in the other windows. A rotational operation is thereby decoupled from a translational operation.

The invention relates to a method for depicting on a screen an object imaged in a volume data record.

Volume images recorded by modern imaging biomedical engineering instruments have a high resolution in all directions. Such imaging biomedical instruments include, for example, x-ray instruments, computed tomography instruments, magnetic resonance imaging instruments or ultrasonic instruments and PET scanners. The high resolution when recording the volume data underlying the volume images leads to a correspondingly large amount of data, which is why viewing and evaluating these data is very time-consuming, predominantly also because it is often not easy to orient oneself in these data records. This applies also, in particular, to the application in the operating theater, where the focus should be directed wholly to the patient and the therapy instruments, and additional image information should be registrable very vividly, i.e. directly. Therefore, improved operating means and navigation aids are necessary and valuable.

Usually, the most used and best method for a 3D image diagnosis to date is the so-called multiplanar reconstruction (MPR). MPR is nothing else than a new formation of the volume data record in a different orientation than e.g. the original horizontal slices. In the case of “orthogonal” multiplanar reconstruction, use is made of three MPRs, each of which is perpendicular to one coordinate axis. Where there are oblique layers, which are obtained from the originally orthogonal data stack by way of e.g. trilinear interpolation, this is often referred to as to “free” MPR. However, all MPRs still tend to be two-dimensional depictions, following the intuitive image impression, the 3D interpretation of which only becomes possible by an overview over a plurality of MPRs.

A depiction of an object on a screen with the aid of a plurality of MPRs is known from US 2008/0074427 A1. However, the operation, which allows the observer to comprehensively modify the views in each individual depiction with effects on the respective other depictions, quickly leads to views which can only be understood with difficulty, making a quick 3D interpretation difficult.

A real volume depiction extending beyond the two-dimensional depiction is very advantageous for various surgical applications. For this purpose, the volume rendering technique (VRT), for example, is advantageous. In VRT, the cone of vision of the observer is remodeled, with planes of the volume data perpendicular to the central ray being superposed. The superposition can be carried out more or less transparently and with some artificial intelligence such that it is possible, for example, to depict only exposed surfaces or else structures lying behind one another plastically in 3D. What is advantageous in VRT depictions is that different colors can be assigned to different materials. Moreover, it is possible to add illumination and shadowing effects.

However, details, in particular of small objects and objects depicted by thin layers, are often lost in real 3D depictions. Moreover, real 3D depiction methods have not found complete acceptance to date because radiologists in particular are strongly “shaped” by conventional orthogonal layer orientation. Moreover, especially in surgical planning, it is often necessary to orient oneself along plane, usually orthogonal views which are, however, usually aligned obliquely overall in relation to the overall volume.

It is an object of the invention to provide a technique, by means of which a depiction on a screen of an object imaged in a volume data record, suitable for surgical applications, is more easily possible.

This object is achieved by a method according to claim 1 and by a device according to claim 9 and by a computer program according to claim 10. Advantageous embodiments of the invention are specified in the dependent claims. The advantages and embodiments explained below in conjunction with the method also apply analogously to the device according to the invention, and vice versa.

The invention modifies the already known methods for three-dimensional depictions and combines these into a new method of depicting an object imaged in a volume data record. Instead of specifying a relatively large number of individual operations in a plurality of windows, which are difficult to handle in an operating theater and lead to a confusing overview, a simple method that is intuitive in operation is specified, with the aid of which an immediately understandable plastic depiction is accomplished and the attention to detail of an MPR depiction is ensured at the same time. Here, the depiction is selected in such a way that the orientation and location specification is also clear at all times. To this end, different depictions of the object are imaged simultaneously—after the provision of an appropriate volume data record—on a common screen in a plurality of windows. In the process, a real, i.e. plastic, 3D depiction of a 3D operating element assigned to the object is linked to a plurality of further depictions of the object based on the volume data. Here, there is a coupled depiction in a plurality of windows.

The 3D operating element is preferably the object itself. In particular, the 3D depiction is a real 3D depiction, for example a VRT volume depiction. However, the 3D operating element can also be a symbolic depiction of the patient or of an organ or merely be an orientation object (e.g. an orientation cube or a 3D model of e.g. a bone).

The further depictions are preferably views of new formations of the volume data record, in particular three mutually orthogonal MPR depictions of the object. Below, the further depictions based on volume data are referred to as MPR views and the corresponding windows are referred to as MPR windows, without this being intended to be construed as restrictive.

At least in an initial position, a center of rotation arranged in the center of the window, in which center of rotation a plurality of axes of rotation intersect, is preferably assigned to the 3D operating element. This center of rotation is, at least at initially, identical to the center of rotation of the volume data record. A focus point, which will also be abbreviated to focus below, is assigned to the point of the object which is of particular medical interest, for example to a surgeon. The further views, e.g. MPR views, are arranged in neighboring, preferably directly adjacent windows, preferably in such a way that the imaging locations of the focal point in various windows in each case lie above one another or next to one another in respect of the screen. The focal point is preferably characterized by horizontal and vertical orientation lines, with said focal point lying in the crossing point of said lines. The focal point already defines a three-dimensional position from one MPR view: two coordinates from the horizontal and vertical positions of the orientation lines, i.e. from the coordinates of the points of intersection thereof, and one coordinate from the depth in the volume data record from which this MPR view is obtained. Therefore, the focal point has a defined 3D position in the view of the 3D operating element. The depictions of the 3D operating element and of the MPR views are linked to one another in such a way that a rotation of the 3D operating element about one of the axes of rotation in the one window has as a consequence a corresponding change in the MPR views in all further windows. For the orientation lines and the depth in the MPR slice selection, i.e. for the focal point, this means that the latter are to be updated in the MPR views in accordance with the present rotation(s).

The center of rotation is an imaginary point, or the spatial coordinates thereof, in the coordinate system of the 3D image data. All rotations of the 3D image data are carried out about this center of rotation. The various MPR views depicted in the further windows preferably show the 3D image data from a different direction of view in each case, but they are rotated about the same point using the operating element. Here, the 3D image data are preferably imaged in the further windows as MPR views in such a way that the focus is visible in each one of these further windows. The imaging locations of the focal point in adjacent windows preferably lie above one another or next to one another in respect of the screen. The position in respect of the screen should be understood in such a way in this case that each screen generally depicts a substantially rectangular area which therefore, e.g. in the case of the vertical assembly, should be ascribed a lateral extent and height. The screen edges therefore extend vertically and horizontally. Points lying above one another or next to one another in respect of the screen are then arranged parallel to the respective screen edges.

The windows in which the views are depicted can also be partial windows or window regions of a single large window. Expressed differently, the invention does not require all views to be shown in different windows. A window is, in general, understood to mean a depiction region of a screen, regardless of whether this region is embodied in the style of a “floating” window over a screen background or as a depiction shown directly on the screen.

The invention provides for a new depiction system, namely in view of the window arrangement or layout of the views, and a new system in respect of the operation. The method according to the invention generates a layout on the screen which serves for the simultaneous depiction of a plurality of views, from different directions of view, of the 3D image data in different windows of the screen illustration. The 3D operating element is directly linked to the 3D image data. Each change in the 3D operating element therefore also brings about a modified illustration of the MPR views. As result of this, it is clearly signaled to the observer of the screen how he changes the MPR views by moving the 3D operating element. The observer identifies the changing MPR views on the screen and can accordingly use this to orient himself in the conventional slice depiction. At the same time, the observer can also orient himself using the 3D operating element as an immediately understandable plastic depiction.

Preferably, there is a centered full image depiction in all windows. Expressed differently, the windows preferably cover the whole volume extent of the object.

Advantageously, a preferred direction of view is assigned to each one of the MPR windows, as described in more detail below. The direction of view can be a direction of view customary for an observer of the view and it is therefore selectable in an observer-dependent manner. Medical practitioners are often the observers of the screen; they are used to specific directions of view of patients due to their many years of work experience with 2D images. Such a customary direction of view can be preset on the screen or in the window for the observer such that the latter is always confronted with the customary view on the screen, and this view can optionally only be varied within specific boundaries.

Likewise, the direction of view can be a conventional direction of view for a medical measure to be carried out on the basis of the 3D image data and it is therefore selectable in a manner dependent on the application. This is because, by default, e.g. fluoroscopy images are recorded from very specific directions of view for specific medical measures. This direction of view can likewise be preset as a window view for the 3D image data and it therefore likewise constitutes a customary view for the observer. Frequently used directions of view are frontal, axial, lateral, LAO or RAO directions of view, i.e. obliquely 45° from the front, in this case.

Preferably, the directions of view of the views in the windows are perpendicular to one another, at least in an initial situation. Therefore, particularly in the case of the three further windows, three mutually orthogonal views are depicted on the screen. Image contents of the individual windows can be assigned to one another in a customary manner. What also applies to this is that such views are by all means customary to an observer, e.g. a medical practitioner.

The windows in the screen can be arranged in the style of the views in the DIN normal projection [DIN 6-1 (DIN ISO 5456-2)] of a technical drawing. The interpretation of image contents arranged next to one another or underneath one another can therefore be interpreted as an imaginary tilt of the image content or of the 3D image data. This also intuitively simplifies the interpretation of the 3D image data depicted on the screen.

In a preferred embodiment of the invention, each direction of view in the case of an arrangement with exactly three further windows and three orthogonal directions of view is permanently linked to one of the windows. Expressed differently, the observer finds the same MPR view in the same window of the screen every time. This is helpful for a quick acquisition of the image information. Together with the window in which the 3D operating element is imaged, the four window arrangement according to the invention emerges with the advantages, described above, in the case of handling the volume data and orientation within these data.

In a preferred embodiment of the invention, an initial arrangement of the views (prior to rotations) is imaged on the screen, with one window with a frontal (coronal) view of the 3D image data being arranged thereon, laterally next to said window there is a further window with a lateral (sagittal) view and, above or below the window with the frontal view, there is a window with an axial view. This substantially corresponds to the aforementioned DIN normal projection, with “lateral” and “above or below” once again being intended to be understood within the meaning of the aforementioned definition of the screen edge. Therefore, the observer immediately identifies the direction of view available in relation to the 3D image data in the corresponding window for each window. In this case, the window with the 3D operating element is situated next to the three windows, preferably obliquely opposite the window with the frontal view, to be precise in such a way that it adjoins the windows with the axial and the lateral view. Expressed differently, the window with the 3D operating element is obliquely opposite to the window with the frontal view.

For the purposes of improved acquisition of the information and/or handling of the depictions, crosshairs are depicted in at least one of the windows with the MPR views, preferably in all MPRs and even in the window of the 3D operating element. As a result of this, a respective view in a different window can be visualized in various windows. By way of example, the lines of the crosshairs in one window can thus correspondingly be the cut lines for the depiction of the image content in other windows and can serve as orientation lines. Therefore, the degree of freedom of the corresponding possible changes in a view is also visualized. The orientation lines in the style of crosshairs are displayed in the 3D window in any case. Optionally, the orientation lines are also shown in the MPR windows. The orientation lines or crosshair lines are aligned parallel to the window edges. The crosshair lines are optionally omitted around the crossing point. The focus is defined there, i.e. that region of detail which is targeted or to which particular attention is directed. The crosshairs can also be imaged in the window with the 3D operating element in order to allow the observer to orient himself quickly.

It is particularly advantageous to image orthogonal MPRs with the same scale factor in the MPR windows. This enables continuous orientation lines, i.e. orientation lines extending from one MPR window into an adjacent MPR window, for a direct simultaneous height and side displacement display in adjacent images. In a particularly preferred embodiment of the invention, at least one orientation line therefore extends over a plurality of MPR windows.

In a further embodiment of the invention, a first one of the MPR windows is provided with an identifier and an indicator representing the view of the first MPR window is depicted in a second of the MPR windows by way of the same identifier. Such an indicator once again visualizes the view of the first MPR window, e.g. in the form of a cut line. Particularly in the case of a plurality of views, the identifier serves to visualize which indicator belongs to which view. The identifier can be a color identifier. By way of example, an MPR window can have a colored frame and an indicator with the same color can visualize the respective view, which can be seen in the MPR window bordered by the appropriate color, in the adjacent MPR window. The indicator can be a cut line if a corresponding cut is depicted in the first MPR window. Preferably, colored orientation lines or crosshair lines serve as an indicator together with corresponding color-coded frames.

In a particularly preferred embodiment of the invention, operating or setting the rotation is decoupled from operating or setting the translation.

By way of example, the 3D operating element can be swiveled about one or more of the axes of rotation in the 3D image data for the purposes of changing the MPR views. Therefore, the rotation is carried out about the center of rotation, which is preferably also the volumetric center of the object. This leads to a change in the angle of the direction of view on the 3D image data and therefore also to modified MPR views in at least one of the further windows. Here, the rotation is always operated in the 3D window; in this case, this is always separate from, and independent of, a possible translation. The rotation is carried out by “grabbing” the 3D object at a point facing the observer with the aid of a computer mouse or the like. Preferably, a rotation about one of the axes of rotation in the 3D window brings about a simultaneous change of the MPR views coupled to one another in a defined manner and continuous updating of all crosshairs or orientation lines and therefore of the focal point. By contrast, the orientation lines are not placed obliquely in the MPR windows and hence the rigid orthogonal coupling of the MPRs is not released. However, a release by virtue of using one or the other orientation line as operating element about which a focus point is twisted into a no longer orthogonal setting is possible after the difficult rotational and translational basic setting of the views has been completed so that, for example, a so-called semi-coronal (or semi-sagittal, semi-axial) slice depiction is achieved.

In the MPR windows, the translation is operated with the aid of translation operating elements in the form of orientation lines which are arranged horizontally and vertically in respect of the screen, preferably by displacing an orientation line or the crosshairs and therefore by displacing the focal point. Here, such a translation is always carried out separately from, and independently of, a possible rotation. In contrast to rotation about the axis of rotation, a translation leads to a displacement of the part of the medical 3D image data, or of the MPR views thereof, depicted on the screen. By way of example, slices from different depths of the 3D volume are depicted in the MPR views. Displacing an orientation line in one of the MPR windows brings about a change in the depiction in that further MPR window which is represented by this orientation line. Displacing both orientation lines (crosshair lines) in one of the MPR windows, i.e. displacing the crosshairs in this window, brings about the simultaneous change in the two other MPR windows. In so doing, only the position of the crosshairs directed to the focal point changes in the 3D window.

In the case of an arbitrary rotational or translational operation, i.e. a rotation or a translation (change in the slice depth) with the aid of the 3D operating element or the translation operating element, all views and the orientation lines depicted therein, the crossing point of which mark the crosshairs, are automatically updated. This means that all views extend through a common object-related focal point at all times. Therefore, every action in one window brings about a change, or updating, in all other windows, even if this is only a displacement of the crosshairs. Expressed differently, each rotation or translation also influences all other image windows, which are preferably updated continuously. Hence, all depictions show the focus and the surroundings thereof at all times. Therefore, in the invention there is a simplified control of the rotation by way of the plastic 3D operating element in relation to known solutions. Here, each rotation brings about appropriate updating of the focal point. The continuous orthogonality of the MPR views is however not given up in the process. Expressed differently, the orthogonality of the views is always maintained, even in the case of a change in the depiction, in particular a rotation or translation. The focus is in the correct position in all views after at most two translations, even if there previously was no rotational setting. The focus is maintained in the case of further rotational adjustments.

The display elements, such as orientation lines, crosshairs or pixels, preferably change continuously, i.e. already during the operation of the 3D operating element as well.

Therefore, a very simple orientation in 3D image data is possible using the depiction, provided by the present invention, on a screen of an object imaged in a volume data record. This simple orientation moreover allows simplified target guidance and navigation.

Thus, when using the VRT technology, density-based or material-based “windowing” is possible, for example, in the 3D depiction. For the purposes of setting the 3D orientation and 3D position (for example for inserting a so-called K-wire into a bone), a depiction of the target point in the bone at the depth is e.g. carried out first by appropriate windowing and the rotation and the translation can be set in such a way that the target point lies in the focus. Thereupon, it is possible to “trace back” in the 3D image with the windowing such that, for example, the skin surface is depicted. Therefore, the insertion point with the desired orientation is obtained in the center of the crosshairs. Expressed differently, a target point in the depth is established first in one embodiment of the invention. Subsequently, a distal insertion point (on the skin) is derived therefrom and displayed. The incidence on the volume can also be determined automatically by computation and this point can be marked in the two orthogonal MPRs (e.g. the window top right and bottom left) and the path can be shown in these two MPRs.

The device according to the invention is embodied to carry out the described method. Preferably, the device is a data processing unit embodied to carry out all steps linked with the processing of data and/or the actuation of the screen for depicting the window and window contents, in accordance with the method described here. The data processing unit preferably has a number of functional modules, with each functional module being embodied to carry out a specific function or a number of specific functions in accordance with the above-described method. The functional modules can be hardware modules or software modules. Expressed differently, the invention, to the extent that it relates to the data processing unit, can be implemented either in the form of computer hardware or in the form of computer software, or as a combination of hardware and software. To the extent that the invention is implemented in the form of software, i.e. as a computer program product, all described functions are realized by computer program instructions when the computer program is executed on a computer with a processor. Here, the computer program instructions are implemented in a manner known per se in any programming language and can be provided by the computer in any form, for example in the form of data packets that are transmitted over a computer network or in the form of a computer program product stored on a disk, a CD-ROM or any other data medium.

The above-described properties, features and advantages of the invention, and the manner in which they are achieved, become clearer and more easily understandable in conjunction with the following description of the exemplary embodiments, which are explained in more detail in conjunction with the drawings. In detail:

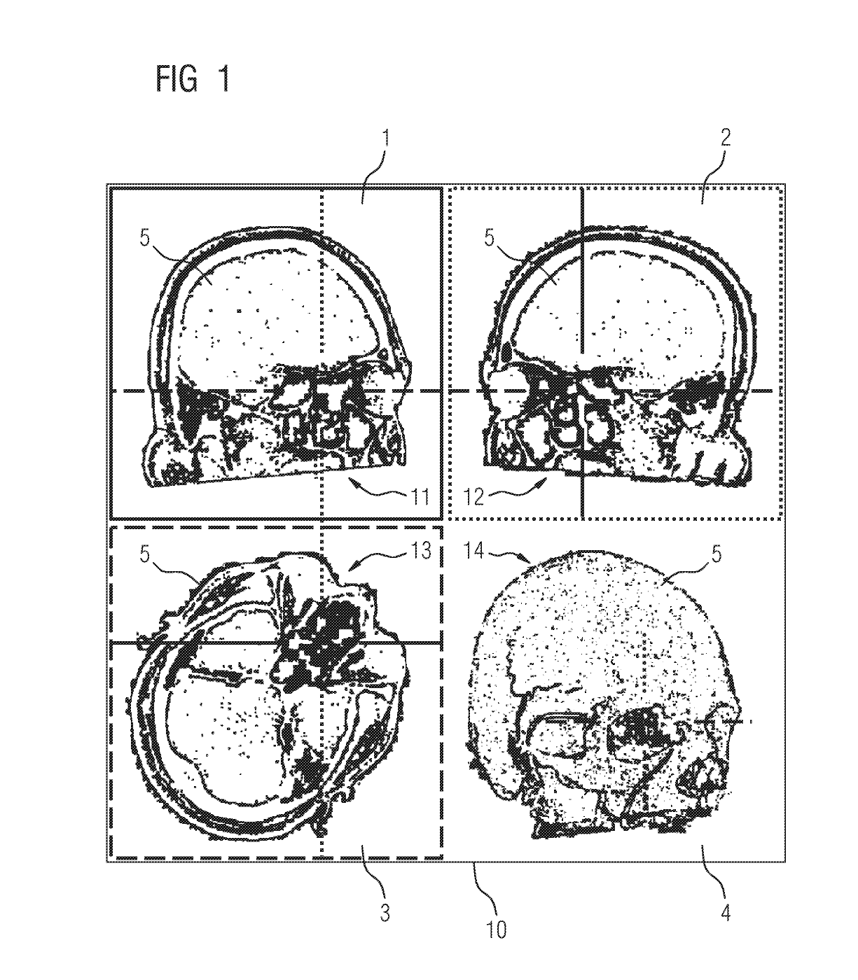

FIG. 1 shows the overall layout with the object to be imaged, and

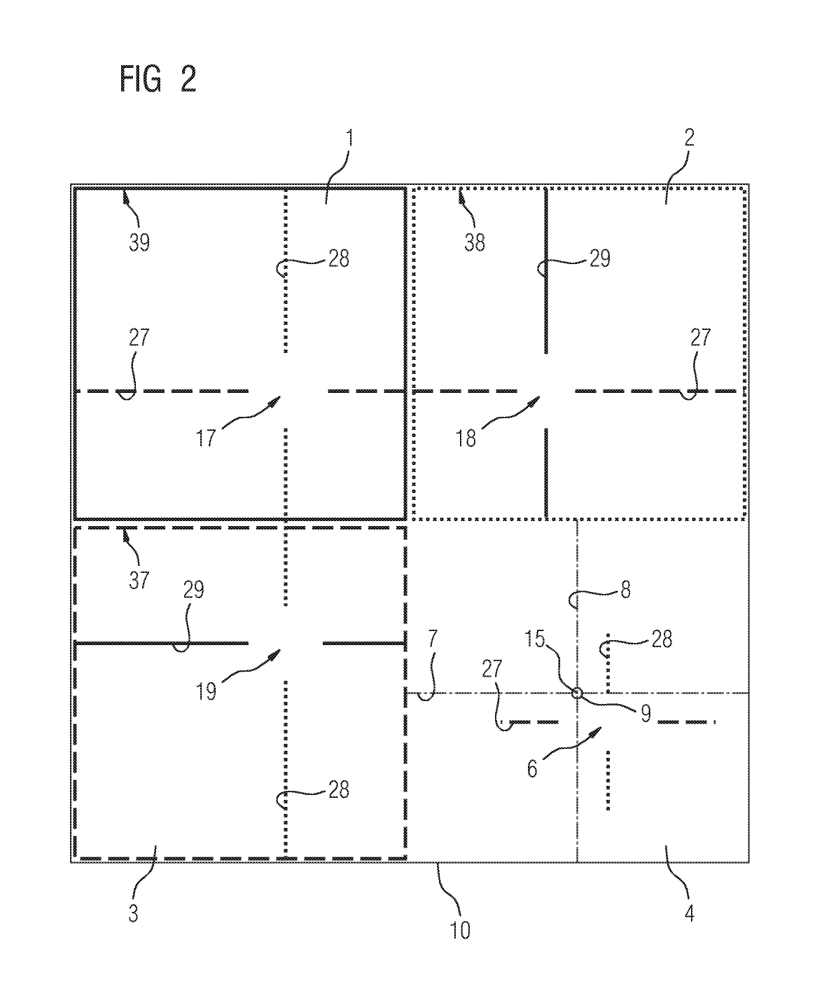

FIG. 2 shows the arrangement of the windows, orientation lines and the like.

All figures show the invention only schematically and with the essential components thereof. Here, the same reference signs correspond to elements with the same or a comparable function.

On the basis of the volume data record provided, different depictions of an object 5, in this case a human skull, are shown simultaneously in four equally sized windows 1, 2, 3, 4 or partial windows, arranged adjacent to one another in the style of squares, on a screen 10.

Therefore, four windows 1, 2, 3, 4 are arranged in a preferred embodiment of the invention, wherein a first window 1 top left contains a coronal MPR view 11 (from the front), a second window 2 top right contains a sagittal MPR view 12 (from the left in relation to the patient) and a third window 3 bottom left contains an axial MPR view 13 (from below in the direction of the head of the patient). The MPR views 11, 12, 13 are orthogonal to one another, i.e. the directions of view of the views 11, 12, 13 in the windows 1, 2, 3 are perpendicular to one another. A fourth window 4 with a plastic operating element 14 is arranged bottom right. A VRT volume depiction of the object 5 serves as operating element 14.

The object 5 is completely imaged in all windows 1, 2, 3, 4. A center of rotation 15 arranged in the center of the window 4 in the initial position at the start of the imaging process is assigned to the operating element 14 in the fourth window 4, with a plurality of axes of rotation 7, 8, 9 intersecting at said center of rotation. Here, the first axis of rotation 7 extends horizontally and the second axis of rotation extends vertically in relation to the screen 10. The third axis of rotation 9 is perpendicular to the plane of the screen or window. Here, the center of rotation 15 at the same time corresponds to the central point of the object volume, wherein this central point can be specified as (nₓ/2, n_{y}/2, n_{z}/2) in the case of a total of nₓ, n_{y}, n_{z} voxels in the volume data record.

A point of the object 5 of particular medical interest is defined as focal point 6, wherein the imaging locations 17, 18, 19 of this focal point 6 respectively lie above one another or next to one another in respect of the screen 10 in the further windows 1, 2, 3. In an initial position, the focal point 6 is in the window center in the windows 1, 2, 3.

Crosshairs centered at the focal point 6 are depicted in all four windows 1, 2, 3, 4. Here, the crosshair lines serve as orientation lines and they are depicted in color in each case, with the various colors being symbolized by lines with different embodiments in FIGS. 1 and 2.

In this arrangement, the upper MPR orientation line 27 (dashed line) extending horizontally in both upper windows 1, 2 is continuously at the same height and shows the z height of the focus in the patient, to be precise from the front (left anterior-posterior, AP) and from the left side of the patient (lateral, LAT). The left-hand orientation line 28 (dotted line) extending vertically is likewise continuous in the images 1, 3 situated above one another on the left and it shows the lateral displacement of the focus, both in the AP view and in the axial (caudocranial) view. The orientation line 29 extending horizontally in the window 3 bottom left corresponds to the orientation line 29 arranged vertically in the window top right 2 (full lines).

The upper left-hand window 1 shows the orientation corresponding best to the application, that is to say, for example, the manner in which the patient lies on the table. The 3D window 4 shows the same orientation plastically. The orientation line 28 depicted by the dotted line, which specifies the lateral position in the object 5, and the orientation line 27 depicted by the dashed line, which specifies the height in the object 5, form the crosshairs on the operating element 14. The third orientation line 29 depicted by the full line shows a further position in the object 5 and it is not reproduced in the fourth window 4 since it does not contribute to the crosshairs.

The MPR view 12 shown in the second MPR window 2 corresponds to the slice through the object 5 defined by the second orientation line 28. In order to elucidate this, the second MPR window 2 is provided with a second frame 38, the color of which corresponds to the color of the second orientation line 28.

The MPR view 11 shown in the first MPR window 1 corresponds to the slice through the object 5 defined by the third orientation line 29. In order to elucidate this, the first MPR window 1 is provided with a third frame 39, the color of which corresponds to the color of the third orientation line 29.

The MPR view 13 shown in the third MPR window 3 corresponds to the slice through the object 5 defined by the first orientation line 27. In order to elucidate this, the third MPR window 3 is provided with a first frame 37, the color of which corresponds to the color of the first orientation line 27.

For the purposes of rotating the MPR views 11, 12, 13, the operating element is swiveled about one or more axes of rotation 7, 8, 9, which are not imaged on the screen 10—only imagined—but which are nevertheless depicted in FIG. 2 for illustration purposes. Therefore, a rotation of the operating element 14 about one of the axes of rotation 7, 8, 9 simultaneously brings about correspondingly modified views 11, 12, 13 in the MPR windows 1, 2, 3 with, at the same time, a corresponding adaptation of the positions of the orientation lines 27, 28, 29 in these windows 1, 2, 3. Since the directions of observation of the left-hand upper window 1 and of the 3D window 4 correspond to one another, a rotation of the operating element 14 in the 3D window 4 immediately has an identical rotation of the coronal view 11 in the upper left-hand window 1 as a consequence. The views in the windows 2, 3 top right and bottom left change in accordance with the directions of view thereof. Since the orthogonality of the MPR views 11, 12, 13 does not change in the process, the continuous orientation lines 27, 28 are also preserved.

For the purposes of translation, the crosshairs formed by two orientation lines in each case, in this case the two orientation lines 28, 29, are displaced in one of the MPR windows, for example in the window 1 top right. At the same time, there is a change in the depiction of the other MPR views 11, 13 in each case; slices at different depths are shown. Only the position of the crosshairs changes in the 3D window 4. In other words, the translation is operated by a translational slice selection in the coordinate system of the screen, implemented by displacing orientation lines 27, 28, 29.

After setting the rotation and at most two translations, the desired depictions are shown in the windows 1, 2, 3, 4. Subsequently, provision can be made in a further embodiment of the invention for the strict coupling of the views 11, 12, 13 to be broken up, for example in order to allow a non-orthogonal slice depiction in one MPR window 1, 2, 3 (e.g. a semi-coronal depiction, implemented by rotating an orientation line in an adjacent MPR window). By way of example, there can be a rotation in the image plane of the left-hand upper image to this end, for example by way of the scroll wheel of a computer mouse, on a (multi-)touch screen or the like.

Even though the invention was illustrated more closely and described in detail by the preferred exemplary embodiment, the invention is not restricted by the disclosed examples and other variations can be derived herefrom by a person skilled in the art, without departing from the scope of protection of the invention.

### LIST OF REFERENCE SIGNS

1 First MPR window
2 Second MPR window
3 Third MPR window
4 3D window
5 Object
6 Focus
7 First axis of rotation
8 Second axis of rotation
9 Third axis of rotation
10 Screen
11 First MPR view
12 Second MPR view
13 third MPR view
14 3D operating element
15 Center of rotation
17 First imaging location of the focus
18 Second imaging location of the focus
19 Third imaging location of the focus
27 First orientation line
28 Second orientation line
29 Third orientation line
37 First frame
38 Second frame
39 Third frame

1-10. (canceled)

11. A method of depicting on a screen an object imaged in a volume data record, the method comprising the following steps:
providing a volume data record;
displaying a 3D operating element assigned to the object in a window of the screen, wherein a center of rotation is assigned to the 3D operating element, wherein a plurality of axes of rotation intersect in the center of rotation, and the center of rotation is identical to a center of rotation of the volume data record;
displaying a number of views, based on the volume data record, in a number of further windows of the screen, carrying out a translation within the meaning of a depth selection of the views that are based on the volume data record in each one of the further windows using respectively one translation operating element, assigned to one of the views and being displaceable within a window, the translation operating element being an orientation line that is imaged in at least one of the windows and arranged horizontally or vertically relative to the screen, at least in an initial position thereof; and
linking the depictions of the 3D operating element and of the views to one another so that a rotation of the 3D operating element about one of the axes of rotation in one window causes a corresponding change in the views in all further windows;
wherein the rotation and the translation are decoupled from one another.

12. The method according to claim 11, wherein a plurality of orientation lines extend continuously over two adjacent further windows and, in the respective views displayed therein, indicate an equal height position or an equal lateral position, from which positions the image data of the view displayed in a respective third further window emerge.

13. The method according to claim 11, which comprises providing the 3D operating element in the window and/or providing the object in the further windows such that a center of the window is assigned to the central point of the object volume, at least in an initial position thereof.

14. The method according to claim 11, which comprises arranging a center of rotation in a center of the window, at least in an initial position thereof.

15. The method according to claim 11, which comprises displaying a volume rendering technique volume depiction of the object itself as a 3D operating element assigned to the object and/or displaying three orthogonal multiplanar reconstruction views as the views based on the volume data record.

16. The method according to claim 15, which comprises maintaining an orthogonality of the MPR views in the case of a change in the depiction.

17. The method according to claim 11, wherein, in the case of any rotational or translational operation, all of the views extend through a common object-related focal point at all times, and mark the focal point as a point of intersection of the orientation lines, by way of suitable updating.

18. The method according to claim 17, which comprises setting a view in at least one of the further windows such that the focal point corresponds to a target point of the object in order subsequently to depict at the 3D operating element a surface point corresponding to the target point.

19. A device for carrying out the method according to claim 11, the device comprising:
a device for providing a volume data record;
a device for depicting in a window of a display screen a 3D operating element assigned to an object, wherein a center of rotation is assigned to the 3D operating element, a plurality of axes of rotation intersect in the center of rotation, and the center of rotation is identical to a center of rotation of the volume data record;
a device for depicting views of new formations of the volume data record in a plurality of further windows of the display screen;
a device for carrying out a translation within the meaning of a depth selection of the views based on the volume data record in each one of the further windows, in each case using a translation operating element, in the form of an orientation line, assigned to one of the views and displaceable within a window, the translation operating element being imaged in at least one of the windows and arranged horizontally or vertically in respect of the screen, at least in an initial position thereof;
a device for linking the depictions of the 3D operating element and the views to one another such that a rotation of the 3D operating element about one of the axes of rotation in one window causes as a consequence a corresponding change in the views in all further windows; and
wherein a rotational operation and a translational operation are decoupled from one another.

20. A computer program for depicting on a screen an object imaged in a volume data record, the computer program comprising:
computer program instructions for providing a volume data record when the computer program instructions are executed on a computer;
computer program instructions for depicting in a window of the screen a 3D operating element assigned to the object when the computer program instructions are executed on the computer, wherein a center of rotation is assigned to the 3D operating element, in which center of rotation a plurality of axes of rotation intersect, and wherein the center of rotation is identical to a center of rotation of the volume data record;
computer program instructions for depicting views of new formations of the volume data record in a plurality of further windows of the screen when the computer program instructions are executed on the computer;
computer program instructions for carrying out a translation within the meaning of a depth selection of the views based on the volume data record in each one of the further windows, in each case using a translation operating element, in the form of an orientation line, assigned to one of the views and displaceable within a window, which translation operating element is imaged in at least one of the windows and arranged horizontally or vertically in respect of the screen, at least in an initial position thereof, when the computer program instructions are executed on the computer;
computer program instructions for linking the depictions of the 3D operating element and the views to one another in such a way that a rotation of the 3D operating element about one of the axes of rotation in the one window has as a consequence a corresponding change in the views in all further windows when the computer program instructions are executed on the computer;
wherein a rotational operation and a translational operation are decoupled from one another.
